(19) United States
(12) Patent Application Publication
(10) Pub. No.: US 2024/0398507 A1
(43) Pub. Date: Dec. 5, 2024

(54) RECIPROCAL MOTOR MOVEMENT FOR ENDODONTIC FILES

(71) Applicant: DENTSPLY SIRONA Inc., York, PA (US)

(72) Inventor: Benoit CAIREY-REMONAY, Les Hopitaux Neufs (FR)

(73) Assignee: DENTSPLY SIRONA Inc., York, PA (US)

(21) Appl. No.: 18/731,486

(22) Filed: Jun. 3, 2024

Related U.S. Application Data
(60) Provisional application No. 63/470,573, filed on Jun. 2, 2023.

(51) Int. Cl. A61C 1/00; A61C 1/12; A61C 5/40

(52) U.S. Cl. CPC A61C 1/003; A61C 1/12; A61C 5/40

(57) ABSTRACT

The present disclosure relates to a dynamic self-adaptive reciprocal motor movement optimized for root canal treatment with endodontic files. A smart motor movement is configured to continuously self-adapt its settings in a smooth manner without sudden drastic motor movement changes. This can be obtained by continuously changing motor parameters in response to instantaneous torque measurements, and also taking into consideration the torque evolution instead of merely reacting to the instantaneous torque imposed on the file.

### CROSS-REFERENCE TO RELATED APPLICATIONS

This application claims the benefit of the filing date of U.S. application Ser. No. 63/470,573 filed Jun. 2, 2023, the disclosure of which is incorporated herein by reference in its entirety for all purposes.

### TECHNICAL FIELD

The present disclosure relates generally to the field of dentistry and more particularly to mechanized endodontic instruments and endodontic motors used for cleaning and enlarging a root canal of a tooth. More specifically, the present disclosure relates to a dynamic self-adaptive reciprocal motor movement optimized for root canal treatment with endodontic files.

### BACKGROUND

During endodontic treatment, the use of an endodontic file connected to a motor requires specific motor settings to have an optimized system, particularly in a reciprocation mode. These settings are defined to provide a balance between efficacy (i.e., high dentin cutting rate) and safety (i.e., avoiding file unwinding and file breakage) according to the file design. Having constant settings for a given file is generally limiting in regards of one of the previously noted aspects, because efficacy and safety levels evolve (or change) depending on the root canal anatomy and progression of the file in the root canal. In one aspect, these performance levels can be linked to a torque (T) acting on the file.

Currently, some existing systems combine safety and efficacy performances by applying torque limits from which parameters switch from sets focused on efficacy (large forward angle (αF) and large differences between forward and reverse (αR) angles (i.e., progression angle: Δα=αF−αR) to other sets focused on safety (file unloading by decreasing progression angle Δα). A disadvantage of such system is that torque applied on the file is artificially decreased when unloading the file, while retaining the torque increase due to root canal blockage, for example. That is, once the file is sufficiently unloaded, the motor will switch back to efficient settings and the torque can quickly rise again. However, this leads to an irregular motor movement that alternates between the concerns of safety and efficacy performances, resulting in unstable operation by the user.

Further, unloading of the file leads to direct torque decrease and then, in most cases, to a sudden motor reaction even when no torque limit is involved. This sudden motor reaction is not favorable towards the integrity of the file as it may cause file breakage. Also, the sudden motor reaction can cause a jerk of an instrument containing the file, which can be transmitted in a form of vibration to a handpiece up to the user's hand, hindering accurate and proper control of endodontic treatment.

In view of the problems associated with the prior systems, there remains a need to provide a motor system that is capable of optimizing reciprocating motor movements, and addressing all of the problems discussed above.

### SUMMARY

In one aspect, there is disclosed a method for operating a system for the endodontic treatment of a root canal, the method comprising the steps of: (a) reciprocating an endodontic instrument in a first sequence which comprises one or more predetermined parameters selected from i) a forward angle αF, ii) a reverse angle αR, iii) a progression angle, iv) speed, and v) frequency, while measuring a torque exerted on the instrument during the first sequence; (b) using the torque measurement in step (a) to determine and apply a second sequence according to a predetermined continuous torque dependent function, wherein if the torque measurement is greater than a previously determined amount, one or more of the predetermined parameters in step (a) is decreased in a predetermined fashion, and wherein a torque exerted on the instrument during the second sequence is measured; (c) optionally using the torque measurement from an immediate previous sequence to determine and apply a subsequent sequence according to the predetermined continuous torque dependent function, wherein if the torque measurement is greater than a previously determined amount, one or more of the predetermined parameters in step (b) is decreased in a predetermined fashion, and wherein if the torque measurement is less than a previously determined amount, one or more of the predetermined parameters in step (b) is increased in a predetermined fashion; and (d) optionally repeating step (c).

In another aspect, there is disclosed a system for the endodontic treatment of a root canal, comprising: (i) an endodontic instrument; (ii) an endodontic handpiece having a drive motor for rotating the endodontic instrument releasably attached to the handpiece; and (iii) a control unit for controlling the rotation of the endodontic instrument according to one or more predetermined rotational sequences, wherein the control unit is configured to: (a) reciprocate the endodontic instrument in a first sequence which comprises one or more predetermined parameters selected from A) a forward angle αF, B) a reverse angle αR, C) a progression angle, D) speed, and E) frequency, while measuring a torque exerted on the instrument during the first sequence; (b) use the torque measurement in step (a) to determine and apply a second sequence according to a predetermined continuous torque dependent function, wherein if the torque measurement is greater than a previously determined amount, one or more of the predetermined parameters in step (a) is decreased in a predetermined fashion, wherein a torque exerted on the instrument during the second sequence is measured; (c) optionally use the torque measurement from an immediate previous sequence to determine and apply a subsequent sequence according to the predetermined continuous torque dependent function wherein if the torque measurement is greater than a previously determined amount, one or more of the predetermined parameters in step (b) is decreased in a predetermined fashion, and wherein if the torque measurement is less than a previously determined amount, one or more of the predetermined parameters in step (b) is increased in a predetermined fashion, and (d) optionally repeat step (c)

Example embodiments provide a solution based on a smart motor movement that is configured to continuously self-adapt its settings in a smooth manner for an optimized combination of safety and efficacy performances without sudden drastic motor movement changes. For instance, this can be obtained by continuously changing motor parameters in response to instantaneous torque measurements, and also taking into consideration the torque evolution instead of merely reacting to the instantaneous torque imposed on the file.

In some implementations, an endodontic motor able to evaluate torque is used. The torque exerted on the file is determined once per sequence (defined as a forward angle followed by a reverse angle) to define motor settings used for the next sequence. For every sequence, the settings (e.g., αF, αR, speed, progression angle, and frequency) follow a continuous mathematical torque dependent function enabling a smooth motor movement adaptation with torque evolution. For example, when the torque increases, previously determined settings (e.g., progression angle) decrease in such a way that an overall torque increase is limited, and the file keeps working and progressing in the root canal. This motor control creates an optimized combination of safety and efficacy that smoothly adapts, instead of alternating between the safety and efficacy performances.

In some implementations, setting decreases, even if limited in size and smoothness, can lead to a direct torque decrease which will in turn provoke a setting increase following the continuous mathematical function described above. In order to avoid having alternating performances between safety and efficacy, settings are filtered in case of torque decreases in such way that for a given setting, a difference between setting from the immediate previous sequence (i−1) and the next sequence (i) is limited by a predefined torque dependent damping factor (d=f(T)) (where d is ≥1) that applies to the previous setting value (i.e., αFi=d*αFi−1). This behavior ends after a predefined number of sequences (m), or when the file is subjected to a torque change of direction, or when the predetermined parameters resulting from the continuous torque dependent function are equal to the parameters of the first sequence.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a graph illustrating an evolution of motor angles as a function of torque, according to an example embodiment of the present disclosure.

FIG. 2 is a graph illustrating an evolution of motor angles as a function of torque, according to an example embodiment of the present disclosure.

FIG. 3 is a graph illustrating an evolution of motor angles as a function of torque, according to an example embodiment of the present disclosure.

FIG. 4 is a graph illustrating an evolution of motor angles as a function of torque, according to an example embodiment of the present disclosure.

FIG. 5 is a graph illustrating an evolution of motor angles as a function of torque, according to an example embodiment of the present disclosure.

FIG. 6 is a graph illustrating an evolution of motor angles as a function of torque, according to an example embodiment of the present disclosure.

FIG. 7 is a graph illustrating an evolution of motor angles as a function of torque, according to an example embodiment of the present disclosure.

FIG. 8 is a graph illustrating an evolution of motor angles as a function of torque, according to an example embodiment of the present disclosure.

FIG. 9 is a graph illustrating an evolution of motor angles as a function of torque, according to an example embodiment of the present disclosure.

FIG. 10 is a graph illustrating an evolution of motor angles as a function of torque, according to an example embodiment of the present disclosure.

FIG. 11 is a graph illustrating an evolution of motor angles as a function of torque, according to an example embodiment of the present disclosure.

FIG. 12 is a graph illustrating an evolution of motor angles as a function of torque, according to an example embodiment of the present disclosure.

FIG. 13 is a graph illustrating motor angle progression with torque increases in relation to tooth anatomy, according to an example embodiment of the present disclosure.

FIG. 14 is a graph illustrating the effect of the damping factor on angle evolution during torque release, according to an example embodiment of the present disclosure.

FIG. 15 is a graph illustrating a damping factor as a function of torque, according to an example embodiment of the present disclosure.

FIG. 16 is a flowchart illustrating a method of movement of the motor, according to an example embodiment of the present disclosure.

FIG. 17 is a schematic diagram of a system for an endodontic treatment of a root canal, according to example embodiment of the present disclosure.

FIG. 18 is an illustration of predetermined reciprocating angles of a first sequence according to an example embodiment of the present disclosure.

FIG. 19 is an illustration of reciprocating angles of a second sequence according to an example embodiment of the present disclosure.

FIG. 20 is an illustration of reciprocating angles of x sequence according to an example embodiment of the present disclosure.

FIG. 21 is an illustration of reciprocating angles of y0 sequence according to an example embodiment of the present disclosure.

FIG. 22 is an illustration of reciprocating angles of y1 sequence according to an example embodiment of the present disclosure.

FIG. 23 is an illustration of reciprocating angles of y0 sequence according to an example embodiment of the present disclosure.

FIG. 24 is an illustration of reciprocating angles of y1 sequence according to an example embodiment of the present disclosure.

FIG. 25 is an illustration of reciprocating angles of y0 sequence according to an example embodiment of the present disclosure.

FIG. 26 is an illustration of reciprocating angles of y1 sequence according to an example embodiment of the present disclosure.

FIG. 27 is an illustration of reciprocating angles of z1 sequence according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the torque ranges and/or angle amplitudes are illustrative and are not intended to be limiting in any way. The use of similar or identical reference numbers in the various drawings is intended to indicate the presence of a similar or identical element or feature.

### DETAILED DESCRIPTION

It is an objective of the present disclosure to provide a dental handpiece and control systems in operating a motor of that dental handpiece along with methods of use that operate at appropriate parameters (e.g., rotational angles, progression angle, speed, and frequency), positively act to avoid imparting excessive torque to a file to cause a breakage, reduce the buildup of internal stress in the metal, while properly shaping the canal to receive obturating material.

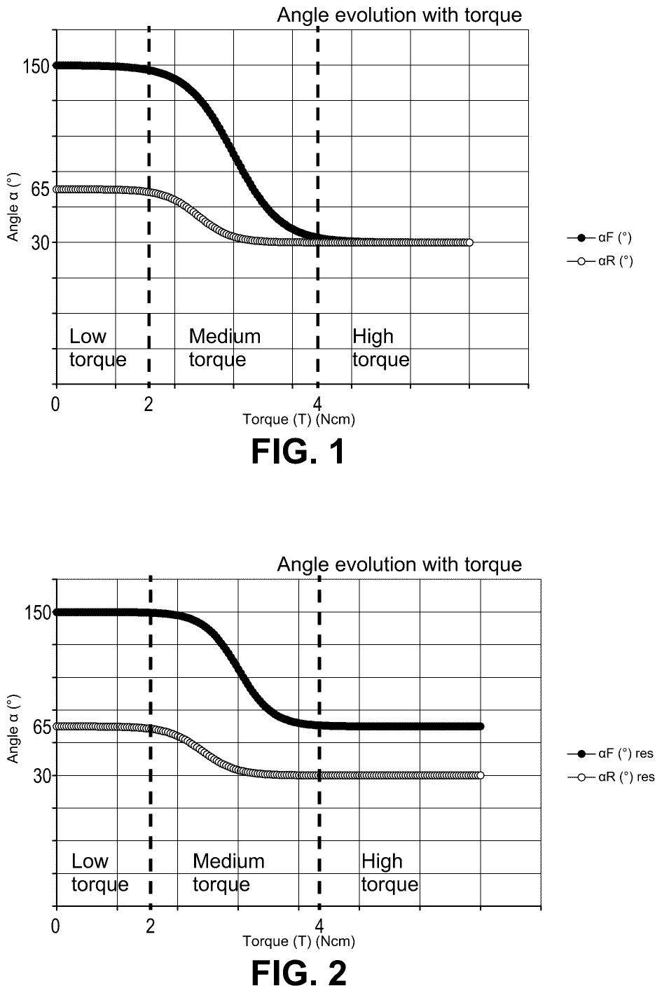

FIG. 1 is a graph illustrating an evolution of motor angle of rotations as a function of torque, according to an example embodiment of the present disclosure. More specifically, the graph of FIG. 1 represents an example of two continuous functions describing evolution of both forward angle of rotation (αF) and reverse angle of rotation (αR) with torque (T) as a single variable. In some implementations, the evolution of angle rotations αF, αR is such that at any torque, the forward angle of rotation αF is consistently larger or equal than the reverse angle of rotation αR. Further, in some implementations, the angle rotations αF, αR remain constant with low torque, and the angle rotations αF, αR start decreasing when torque becomes larger, with the forward angle of rotation αF decreasing higher than the reverse angle of rotation αR. To describe differently, a progression angle: Δα=αF−αR decreases with torque increase. Further, in some implementations, the angle rotations αF, αR stabilize when torque becomes high, with the forward angle of rotation αF equal to the reverse angle of rotation αR.

FIG. 2 is similar to FIG. 1, except that FIG. 2 illustrates an embodiment wherein when the torque becomes high, the forward angle of rotation αF is slightly larger than the reverse angle of rotation αR.

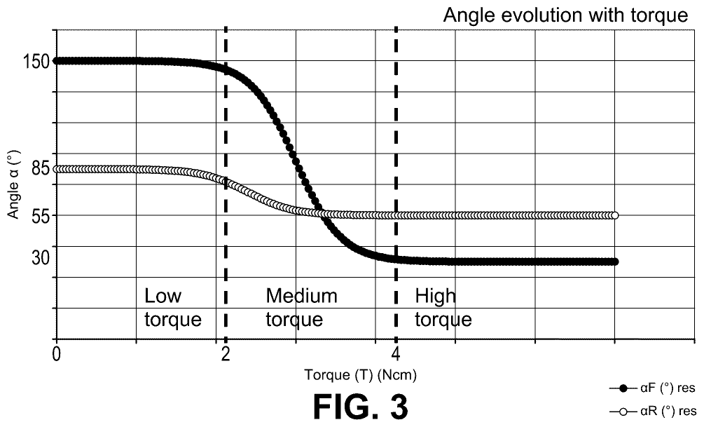

FIG. 3 is a graph illustrating an evolution of motor angle of rotations as a function of torque, according to another example embodiment of the present disclosure. More specifically, the graph of FIG. 3 represents an example of two continuous functions describing evolution of both forward angle of rotation (αF) and reverse angle of rotation (αR) with torque (T) as a single variable. In some implementations, the evolution of angle rotations αF, αR is such that at low torque, the angles remain relatively constant. As the torque becomes larger, the angles start decreasing, with the forward angle of rotation decreasing higher than the reverse angle, i.e., the progression angle decreases with increasing torque. When the torque becomes high, the angles stabilize with the forward angle being slightly lower than the reverse angle (i.e., a negative progression angle).

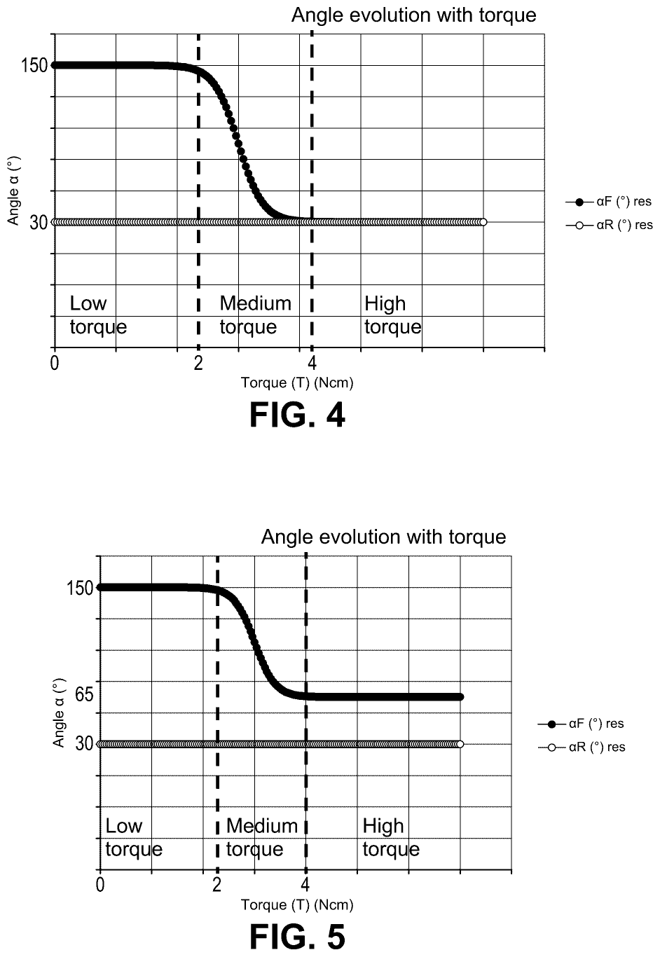

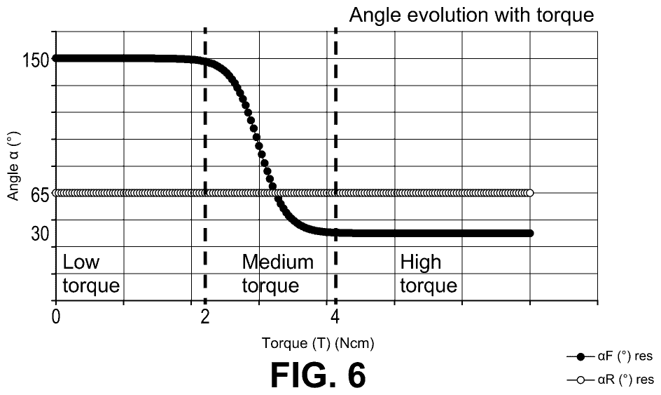

In another embodiment illustrated in FIGS. 4, 5, and 6, the reverse angle remains substantially constant. The forward angle remains substantially constant with low torque, and starts decreasing when torque becomes larger, i.e., the progression angle decreases with increasing torque. The forward angle stabilizes when torque becomes high, being slightly higher than (FIG. 5), substantially equal to (FIG. 4), or slightly lower than (FIG. 6) the reverse angle.

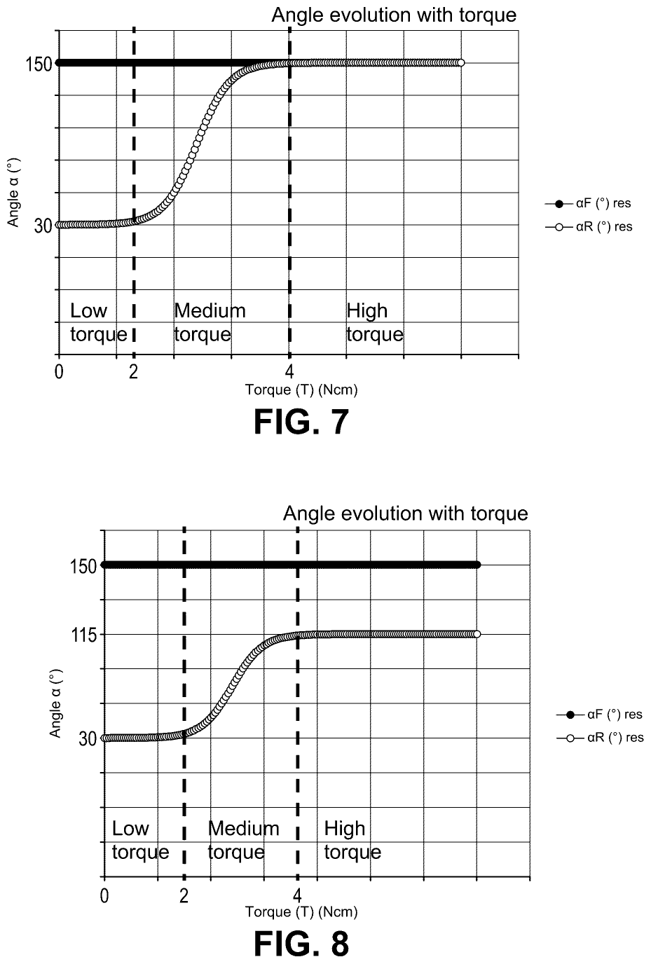

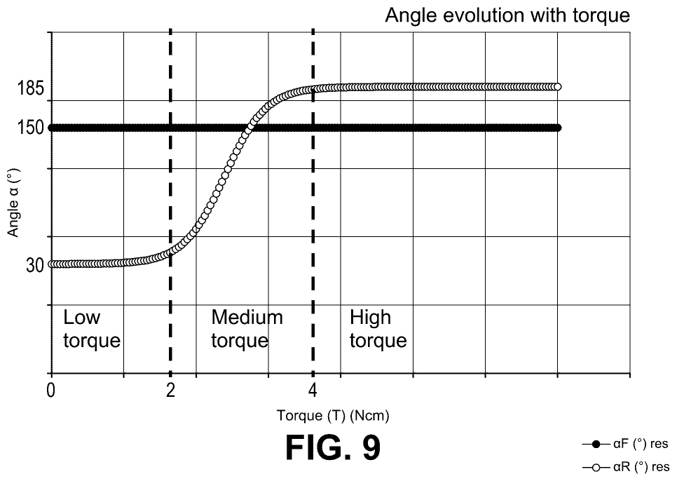

In another embodiment illustrated in FIGS. 7, 8, and 9, the forward angle remains substantially constant. The reverse angle remains substantially constant with low torque, and starts increasing when torque becomes larger, i.e., the progression angle decreases with increasing torque. The reverse angle stabilizes when torque becomes high, being slightly higher than (FIG. 9), substantially equal to (FIG. 7), or slightly lower than (FIG. 8) the forward angle.

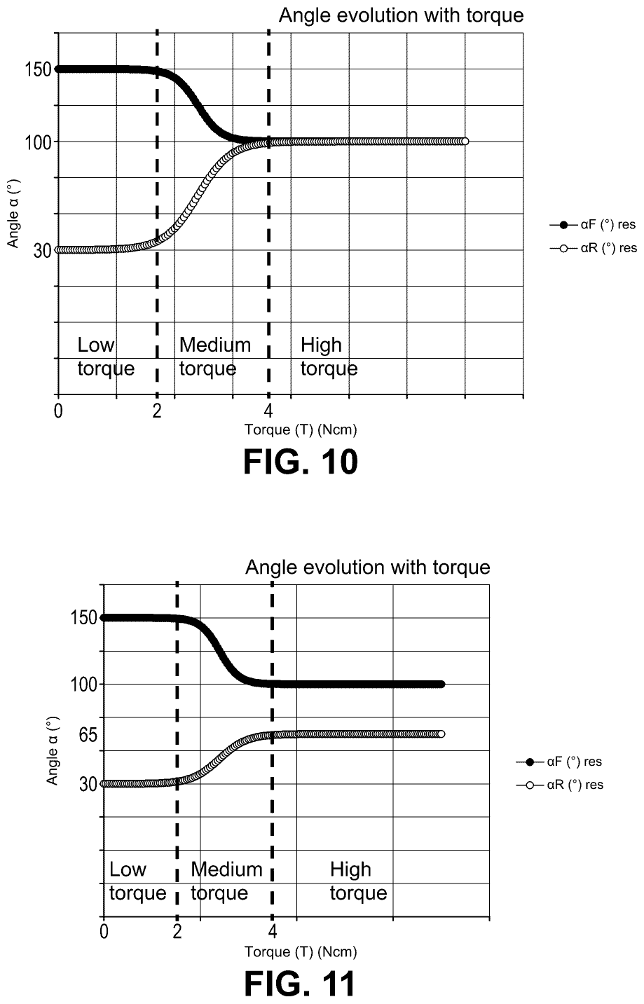

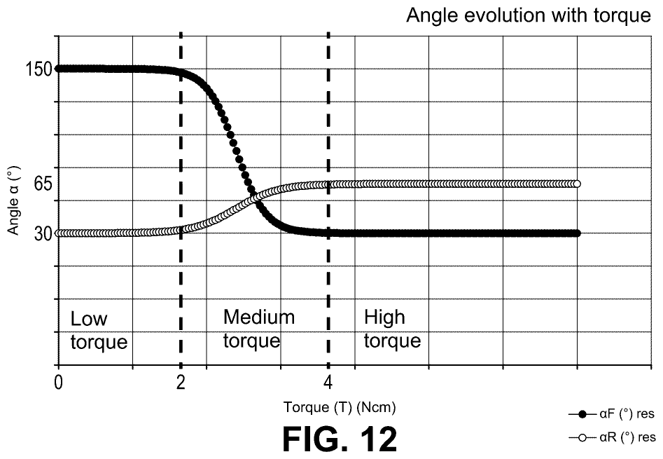

In another embodiment illustrated in FIGS. 10, 11, and 12, both angles remain substantially constant at low torque. When torque becomes larger, the forward angle starts decreasing and the reverse angle starts increasing, i.e., the progression angle decreases with increasing torque. The angles stabilize when torque becomes high, with the forward angle being slightly higher than (FIG. 11), substantially equal to (FIG. 10), or slightly lower than (FIG. 12) the reverse angle.

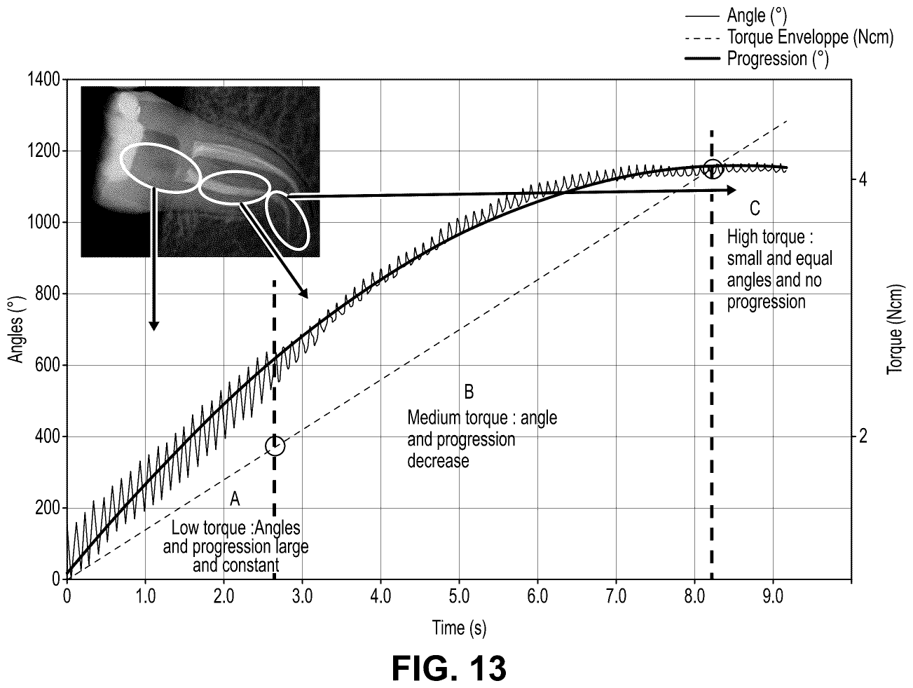

FIG. 13 is a graph illustrating motor angle progression with torque increases in relation to tooth anatomy, according to an example embodiment of the present disclosure (see FIG. 1). As shown, the graph illustrates the alternance of angles αF (angle curve—up sections), αR (angle curve—down sections) with the respective torques acting on a file resulting from root canal anatomy. For example, at area A, where the file enters for a root canal, i.e., coronal third of the canal, low torque is applied; at area B, where the file progresses in a middle of the root canal, i.e., root canal (with diameter decrease and slight curvature), medium torque is applied; and at area C, in the region near the tooth apex or where the file enters the tooth apex (with sharp curvature and narrow canal), high torque is applied. It will be appreciated that the path shown is exemplary as the specific anatomy of a given tooth will vary from person to person and even root canal to root canal and thus the size and conditions of the areas over which different torque is applied will also vary.

In some implementations, when low torque is acting on the file (area A), both the forward angle αF (angle curve—up sections) and the reverse angle αR (angle curve—down sections) remain constant with torque increase. In addition, the graph of FIG. 13 illustrates a progression speed (slope of the black continuous curve) remaining constant as well in area A.

In some implementations, when medium torque is acting on the file (area B), both forward and reverse angles αF, αR decrease with torque increase. The forward angle αF decrease is larger than the reverse angle αR decrease. In this case, the progression speed decreases with torque increase in area B.

In some implementations, when high torque is acting on the file (area C), both forward and reverse angles αF, αR become constant at low values with the forward angle slightly higher than the reverse angle or vice versa, or substantially equal to each other. In this case, the progression speed is equal to 0 in area C, by which there is no more file progression.

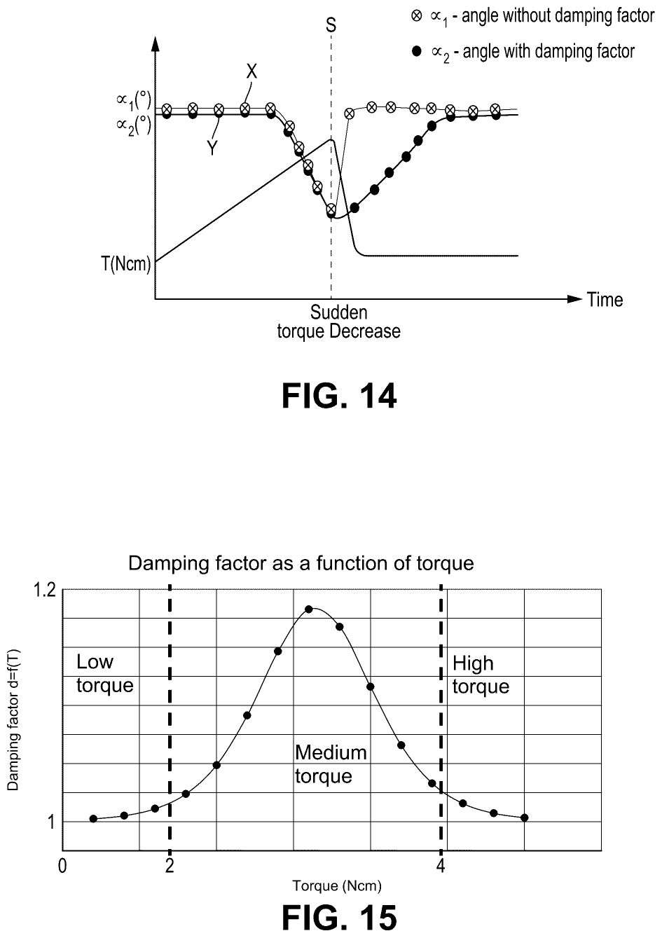

FIG. 14 is a graph illustrating an angle evolution during torque release, according to an example embodiment of the present disclosure. More specifically, the graph of FIG. 14 depicts a behavior comparison showing effect of a damping factor (d) applied to a torque decrease, i.e., (d=f(T)). As shown, curve X indicates an angle α1 without the damping factor (d) and curve Y indicates an angle α2 with the damping factor (d). For example, when a sudden torque release occurs (at S), the angle α1 directly returns from a low value at the point of release to its value in the first sequence. On the other hand, for angle α2, this angle is filtered with the damping factor (d) resulting in a return to the first sequence value over a longer period of time and multiple sequences. In this case, the angle α2 reached its first sequence value at a pre-defined number of sequences (7 sequences, for example in this instance). As such, this creates a more smooth transition, i.e., reduced sudden motor reaction.

In some implementations, the damping factor (d) can be applied to a previous setting value (i.e., αFi=d*αFi−1) (where d≥1), which ends after a predefined number of sequences, or when the file is subjected to a torque change of direction, or when the predetermined parameters resulting from the continuous torque dependent function are equal to the parameters of the first sequence (e.g., a damping factor equal to 1 at low torque).

FIG. 15 is a graph illustrating a damping factor (d) as a function of torque (T), according to an example embodiment of the present disclosure. More specifically, the damping factor (d) is torque dependent (d=f(T)) in order to optimize the combination between safety and efficacy performances. In some implementations, for high torque range, the damping factor effect is significant (compare to absence of damping factor) (i.e., d=f(T)˜1 where d≥1) in a way that delta between the angle from the next sequence (αi) and the angle from the immediate previous sequence (αi−1) is small to promote adequate safety performance with limited parameter change between each sequence. In other implementations, for medium torque range, the damping factor effect is less significant (compare to absence of damping factor) (i.e., d=f(T)>1) in a way that delta between αi and αi−1 is larger to promote adequate safety performance together with improved efficacy with larger parameter change between each sequence (but parameter change still lower than without damping factor). In yet other implementations, for low torque range, the damping factor effect is negligible (i.e., f(T)˜1 where d≥1) (compare to absence of damping factor), as angles are constant in the low torque range and efficacy is at its maximum.

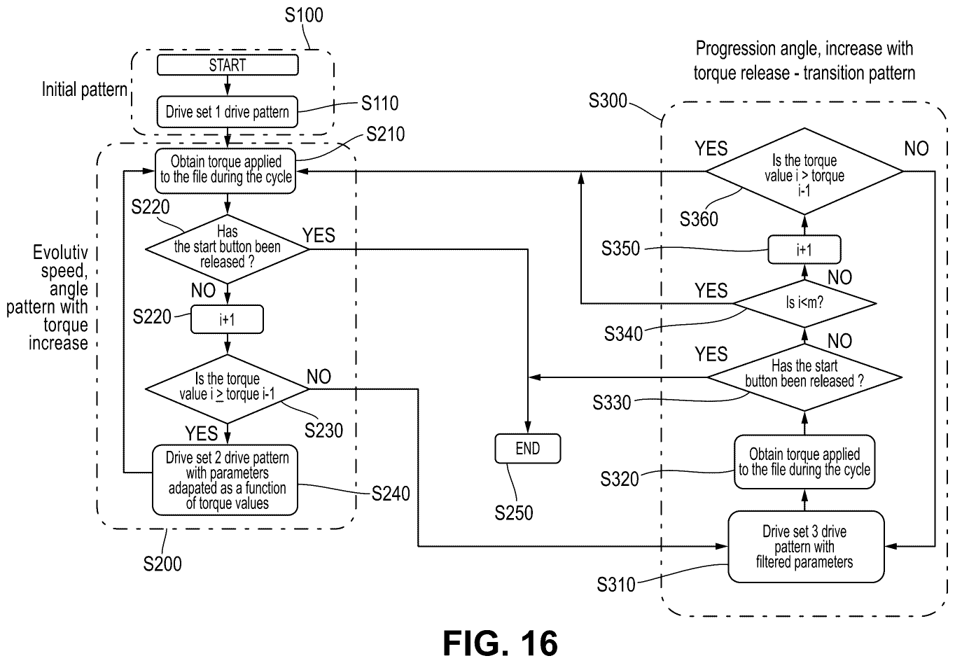

FIG. 16 is a flowchart illustrating a method of movement of the motor, according to an example embodiment of the present disclosure. In step S100, a control unit (not shown) operates a set 1 pattern S110 corresponding to initial predefined parameters. The set 1 pattern (initial pattern) is used as a default for a first sequence, when there is no torque measurement available. In step S200, the control unit operates a set 2 pattern or second sequence (i.e., speed and angle with torque increase) corresponding to parameters calculated from a continuous mathematical torque dependent function, leading to evolution of parameters (e.g., rotational angles, progression angle, speed, and frequency) as previously described with respect to FIGS. 1-12. In step S300, the control unit operates a set 3 pattern or sequence (i.e., progression angle increase with torque release, etc.) corresponding to the situation of torque decrease. In other words, parameters that are filtered using a torque dependent damping factor (d) to produce a smooth evolution and to avoid significant parameter jumps that could alter the integrity of the file, as described by the curve Y (FIG. 14) indicating the angle α2 with the damping factor.

In step S200, the method determines the evolution of angle rotations αF, αR as a function of torque. In one implementation, once the predefined parameters in S100 are run, the method commences to determine the torque applied to the file during a sequence (S210). If the start (e.g., drive/run) mechanism on a handheld instrument (not shown) has been released (S220), the control unit ends (S250) the determination since there is no file progression. If, however, the start mechanism has not been released and the file progresses, the method commences to determine whether the torque value from the next sequence i is greater than the immediate previous sequence torque i−1 (S230). If the torque value i is greater than or equal to the previous torque i−1, the method commences to determine the set 2 pattern with parameters as a function of the torque values (S240) as illustrated in FIGS. 1-12 and drives the motor in accordance therewith. When the motor reaches the next sequence, the method reverts back to S210 to determine the new torque. If the torque value i is lower than the previous torque i−1, the method commences to S310 to determine the set 3 pattern with the filtered parameters as illustrated in FIG. 14. In this determination, the method determines the torque applied to the file during this sequence (S320). If the start mechanism (e.g., a button or pedal) has been released (S330), the control unit ends (S250) the determination since there is no file progression. If, however, the start mechanism has not been released, the method commences to apply a predefined number of sequences (m) during which the damping factor (d) is applied (S340). If the number of sequences in a given configuration is equal to the predefined number of sequences (m), the method reverts back to S210 to determine the new torque. If, however, the number of sequences is not equal to predefined number of sequences (m), the method commences to determine the next torque value (S350). Then, the method commences to determine whether the torque value i is greater the previous torque i−1 (S360). If the torque value i is greater than the previous torque i−1, the method reverts back S210 to determine the new torque. If, however, the torque value is not greater than the previous torque, the method returns to determine the set 3 pattern with parameters with the filtered parameters (S310) of FIG. 14.

TABLE 1

| Motor torque | Forward | Reverse | Progression | Frequency | Plateau |
|---|---|---|---|---|---|
| (Ncm) | angle(°) | angle (°) | angle (°) | (Hz) | speed |
| 0 ≤ X ≤ 10 | 0°-200° ± | 0°-200° ± | 0-180° | 5-25 Hz ± | 50-500 |
| Ncm | 5% | 5% | | 10% | RPM |

Table 1 above provides examples of parameter ranges to define the reciprocation. In one exemplary embodiment, the reciprocation parameters comprise a forward angle of 0°-200°±5%, a reverse angle of 0°-200°+5%, a net progression angle of the file of 0°-180°, a frequency of 5-25 Hz±10%, a plateau speed of 50-500 RPM with a motor torque of 0 to 10 (Ncm). It should be appreciated that the reciprocation parameters are not limited to the embodiments described herein, and other parameters can be employed.

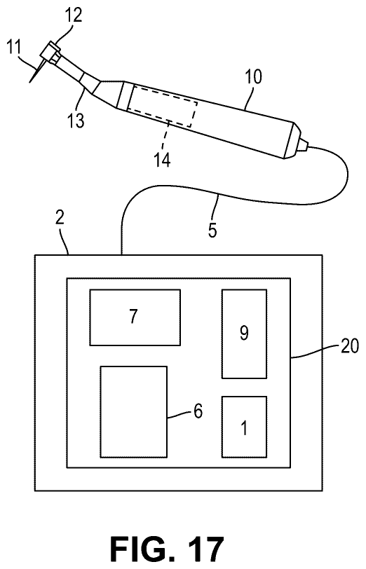

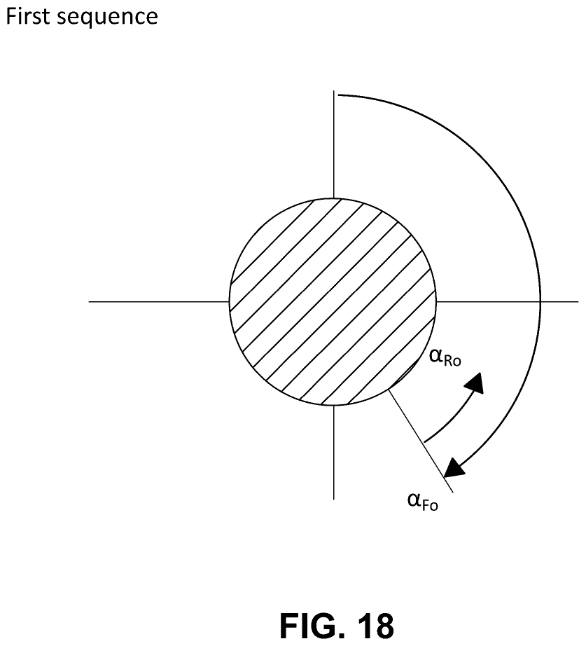

Referring to FIG. 17, as for the system according to example embodiments, it is thus intended that for the control of the movement of a handpiece or instrument 10 provided with at least one cutting tool 11 (e.g., file) for the preparation of a root canal, and a drive device 14 is used comprising at least one drive motor, which can be configured as a stepping motor or a servo motor.

An endodontic file 11 is releasably secured in a chuck of the handpiece head 12. The handpiece 10 further comprises a drive motor 14 fastened to a contra angle 13. The drive motor 14 is connected by a cable 5 to the control apparatus 2 which includes a microprocessor 9. The control apparatus 2 may further contain a memory 1, a keyboard 6, and a display 7. The control apparatus 2 controls the drive motor 14, thereby controlling the rotation of the endodontic file 11 according to the method described herein. The memory 1 may be used to store predetermined rotational sequences. It should be noted that the details of the control apparatus 2 can vary, and that the structures depicted in FIG. 17 are example embodiments. For example, the motor may not have a display, but might have an LED or similar features.

As noted, the drive motor 14 can be connected via cable 5 to a separate power supply and to control apparatus 2. It is, however, also possible to use a battery-operated hand-held device in the case of which the control apparatus 2 and also suitable input and control devices for the manual operation are provided herein.

In some implementations, the control apparatus 2 and the motor handpiece can also include at least a control unit 20, a setting section, a power supply, a driving section, a sensor, a rotation direction switching section, and a current detecting section.

The control unit can be a computer unit including a microprocessor or digital processor, a memory or the like. The display section can include a monitor or the like for displaying information indicative of a load torque as an operating state of the motor, or information used for setting the operation of the motor or the like in the control unit. The setting section can set operating conditions such as a rotation speed, a torque, and a rotation angle of the motor for the control unit, and can retain the set information. In particular, the setting section can retain set information regarding the forward and reverse angles αF, αR. The power supply can supply electric power for allowing the control apparatus and the motor handpiece to operate. The driving section can control voltage levels applied to the motor based on instructions from the control unit in order to control the rotation of the endodontic instrument according to one or more predetermined rotational sequences. The sensor can include a hall element for detecting the rotation angle of the motor, and an encoder. The rotation direction switching section can switch a voltage polarity applied to the motor. The current detecting section can detect a current having passed through the motor, and may convert a current (a motor current) having passed through the motor to a voltage and feeds it back to the control unit. Since a motor current, a motor voltage and a load torque are in a proportional relationship in a DC motor, the control unit can measure the load torque applied to the file based on the fed-back voltage value.

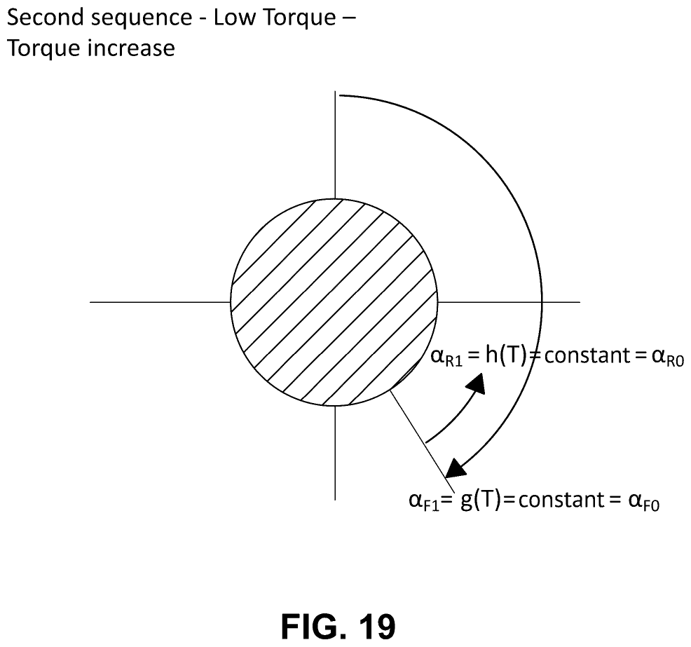

FIGS. 18-27 are additional depictions of the reciprocating angles described herein. FIG. 18 represents predetermined reciprocating forward (α_{FO}) and reverse (α_{RO}) angles of the first sequence when the motor starts. This corresponds to the low torque regions in FIGS. 1-12. FIG. 19 represents reciprocating angles of a second sequence. Both the forward angle (α_{F1}) and reverse angle (α_{R1}) are defined following predetermined torque dependent continuous functions, respectively g(T) and h(T). In this case, as the measured torque has increased but remains low, both α_{F1} and α_{R1} remain constant at values equal respectively to α_{R0} and α_{F0}. As with FIG. 18, this may correspond to the low torque regions of FIGS. 1-12.

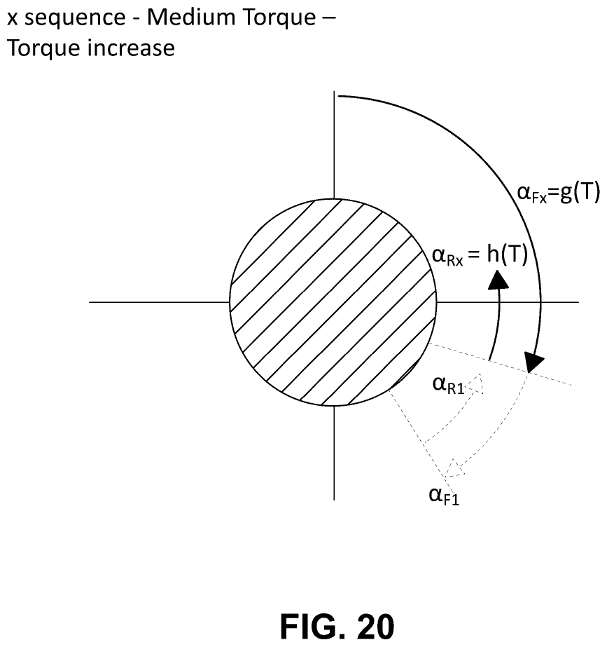

FIG. 20 represents reciprocating angles of x sequence, with x corresponding to a non-defined number of repetitions of the reciprocating sequence where x>2. In this case, the measured torque has increased and becomes medium. Both forward angle (α_{Fx}) and reverse angle (α_{Rx}) are defined following predetermined torque dependent continuous functions, respectively g(T) and h(T). It results in the decrease of both α_{Fx} and α_{Rx} with forward angle of rotation α_{Fx} decreasing higher than the reverse angle of rotation α_{Rx} (α_{Fx}<α_{F1}; α_{Rx}<α_{R1} and α_{Rx}<α_{Fx}). This corresponds to the medium torque regions of FIGS. 1 and 2.

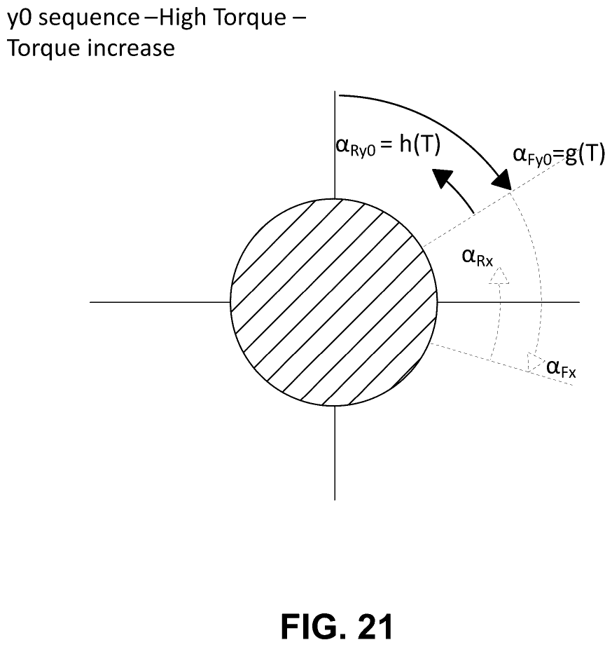

FIG. 21 represents reciprocating angles of y0 sequence, with y corresponding to a non-defined number of repetitions of the reciprocating sequence where y0>x. In this case, the measured torque has increased and becomes high. Both forward angle (α_{Fy0}) and reverse angle (α_{Ry0}) are defined following predetermined torque dependent continuous functions, respectively g(T) and h(T). It results in the decrease of both α_{Fy0} and α_{Ry0} with forward angle of rotation α_{Fy0} decreasing higher than the reverse angle of rotation α_{Ry0} (α_{Fy0}<α_{Fx}, α_{Ry0}<α_{Rx} and α_{Ry0}<α_{Fy0}). This corresponds to the high torque region in FIG. 2.

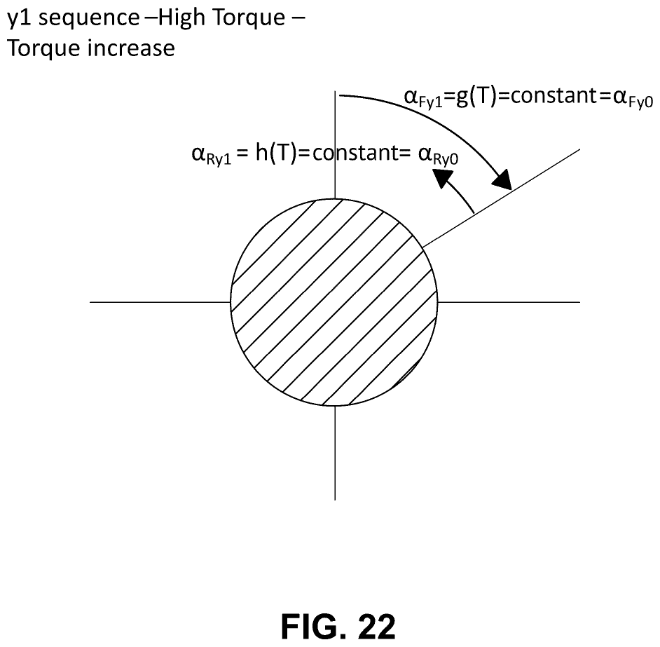

FIG. 22 represents reciprocating angles of y1 sequence where y1>y0. In this case, the measured torque has increased and remains high. Both forward angle (α_{Fy1}) and reverse angle (α_{Ry1}) are defined following predetermined torque dependent continuous functions, respectively g(T) and h(T). In this case, as measured torque has increased and remains high, both α_{Fy1} and α_{Ry1} remain constant at values equal respectively to α_{Fy0} and α_{Ry0}. This corresponds to the high torque regions of FIGS. 2, 5, 8, and 11.

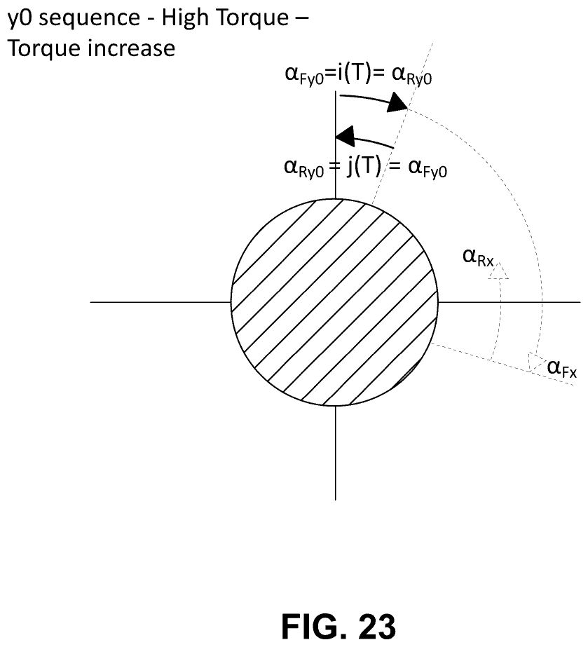

FIG. 23 represents reciprocating angles of y0 sequence where y0>x. In this case, the measured torque has increased and becomes high. Both forward angle (α_{Fy0}) and reverse angle (α_{Ry0}) are defined following predetermined torque dependent continuous functions, respectively i(T) and j(T). It results in a decrease of both α_{Fy0} and α_{Ry0} with forward angle of rotation α_{Fy0} decreasing higher than the reverse angle of rotation α_{Ry0} in such a way that α_{Fy0} equals α_{Ry0} with α_{Fy0}<α_{Fx} and α_{Ry0}<α_{Rx}. This corresponds to the high torque region of FIG. 1.

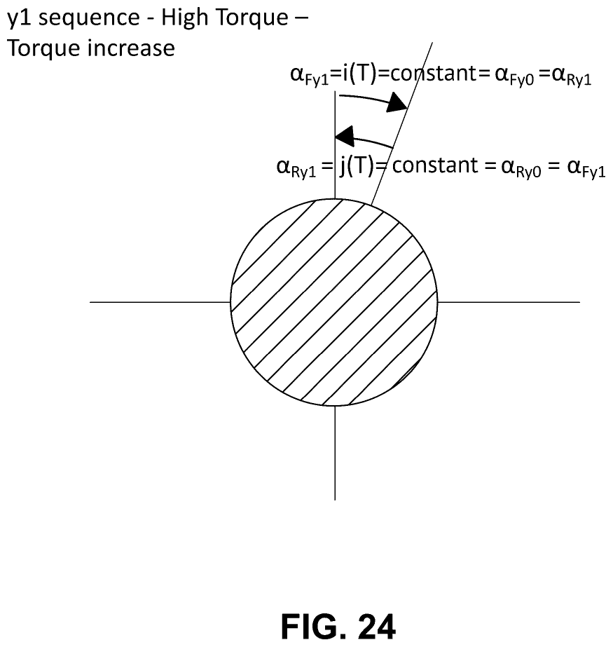

FIG. 24 represents reciprocating angles of y1 sequence where y1>y0. In this case, the measured torque has increased and remains high. Both forward angle (α_{Fy1}) and reverse angle (α_{Ry1}) are defined following predetermined torque dependent continuous functions, respectively i(T) and j(T). In this case, as measured torque has increased and remains high, both α_{Fy1} and α_{Ry1} remain constant at values equal respectively to α_{Ry0} and α_{Fy0} with α_{Fy1}=α_{Ry1}. This corresponds to the high torque regions in FIGS. 1, 4, 7, and 10.

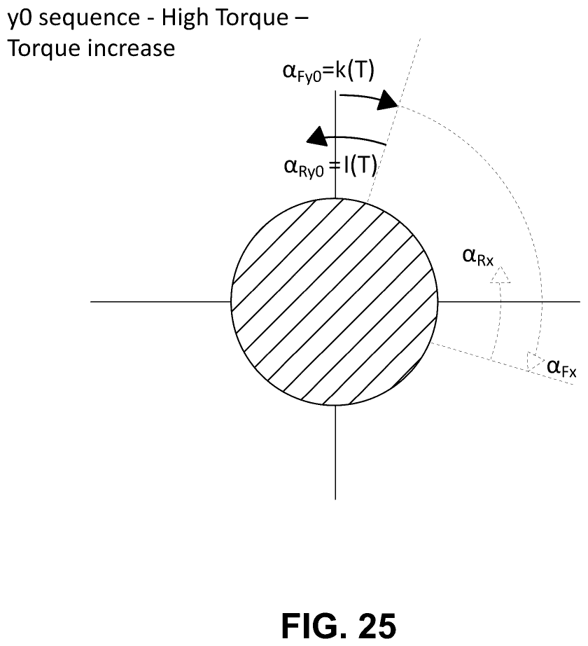

FIG. 25 represents reciprocating angles of y0 sequence where y0>x. In this case, the measured torque has increased and becomes high. Both forward angle (α_{Fy0}) and reverse angle (α_{Ry0}) are defined following predetermined torque dependent continuous functions, respectively k(T) and l(T). It results in decrease of both α_{Ry0} and α_{Ry0} with forward angle of rotation α_{Fy0} decreasing higher than the reverse angle of rotation α_{Ry0} in such a way that the reverse angle becomes larger than forward angle (α_{Fy0}<α_{Ry0} with α_{Fy0}<α_{Fx} and α_{Ry0}<α_{Rx}). This corresponds to the high torque region in FIG. 3.

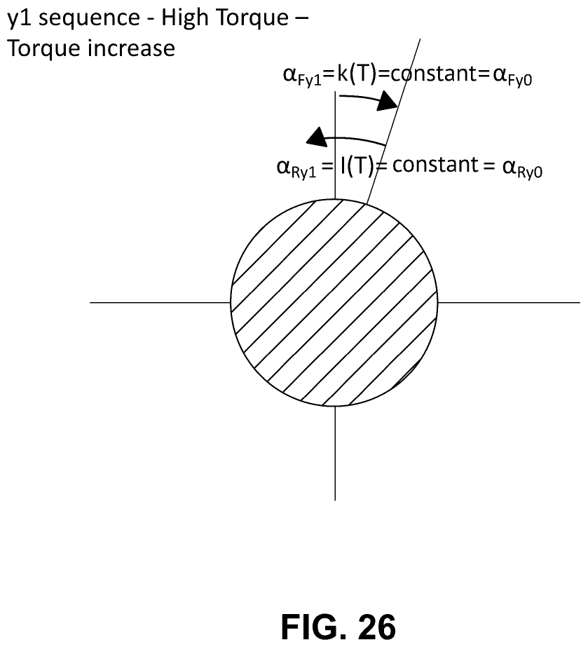

FIG. 26 represents reciprocating angles of y1 sequence where y1>y0. In this case, the measured torque has increased and remains high. Both forward angle (α_{Fy1}) and reverse angle (α_{Ry1}) are defined following predetermined torque dependent continuous functions, respectively k(T) and l(T). In this case, as the measured torque has increased and remains high, both α_{Fy1} and α_{Ry1} remain constant at values equal respectively to α_{Ry0} and α_{Fy0} with α_{Fy1}<α_{Ry1}. This corresponds to the high torque regions in FIGS. 3, 6, 9, and 12.

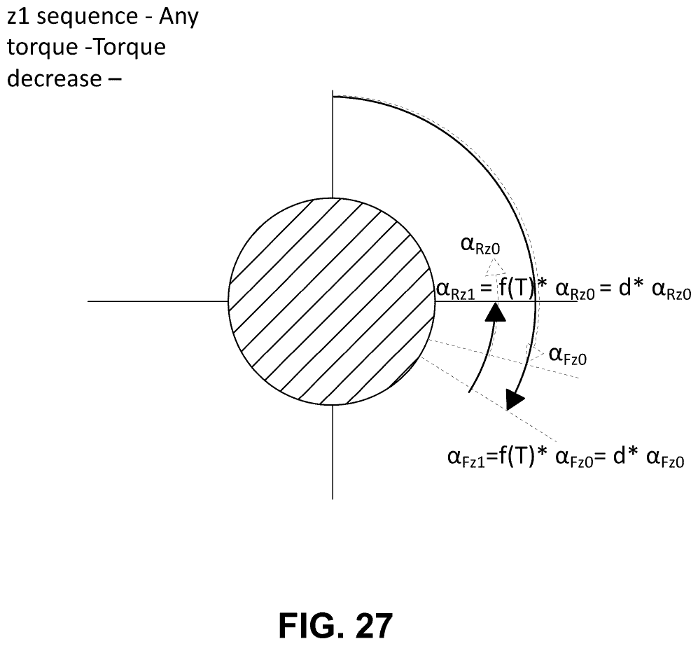

FIG. 27 represents reciprocating angles of z1 sequence, with z corresponding to a non-defined number of repetitions of the reciprocating sequence where z1>2 and z1>z0. In this case, the measured torque has decreased. Both forward angle (α_{Fz1}) and reverse angle (α_{Rz1}) are defined following predefined torque dependent function f(T) also called damping factor (d=f(T)), multiplied by respective angles from previous sequence α_{Fz0} and α_{Rz0}. In this case, as the measured torque has decreased, both α_{Fz1} and α_{Rz1} slightly increase with α_{Fz1}>α_{Rz1}. This corresponds to FIG. 14—angle with a damping factor.

It should be appreciated that specifications and operations of the controller are not limited to the embodiments described herein, but may vary depending on the requirements of the motor.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to one or more preferred embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claim(s).

1. A method for operating a system for the endodontic treatment of a root canal, the method comprising the steps of:
(a) reciprocating an endodontic instrument in a first sequence which comprises one or more predetermined parameters selected from i) a forward angle αF, ii) a reverse angle αR, iii) a progression angle, iv) speed, and v) frequency, while measuring a torque exerted on the instrument during the first sequence;
(b) using the torque measurement in step (a) to determine and apply a second sequence according to a predetermined continuous torque dependent function, wherein if the torque measurement is greater than a previously determined amount, one or more of the predetermined parameters in step (a) is decreased in a predetermined fashion, and wherein a torque exerted on the instrument during the second sequence is measured;
(c) optionally using the torque measurement from an immediate previous sequence to determine and apply a subsequent sequence according to the predetermined continuous torque dependent function, wherein if the torque measurement to or greater than a previously determined amount, one or more of the predetermined parameters in step (b) is decreased in a predetermined fashion, and wherein if the torque measurement is less than a previously determined amount, one or more of the predetermined parameters in step (b) is increased in a predetermined fashion; and
(d) optionally repeating step (c).

2. The method of claim 1, wherein the predetermined continuous torque dependent function decreases the progression angle when the torque measurement is greater than the previously determined amount.

3. The method of claim 2, wherein the progression angle is decreased by decreasing the forward angle in a greater amount than the reverse angle.

4. The method of claim 2, wherein the reverse angle remains substantially constant

5. The method of claim 2, wherein the forward angle remains substantially constant.

6. The method of claim 2, wherein the forward angle is greater than or equal to the reverse angle.

7. The method of claim 2, wherein the reverse angle is greater than the forward angle.

8. The method of claim 1, wherein the predetermined continuous torque dependent function further comprises a predefined torque dependent damping factor.

9. The method of claim 8, wherein the predefined damping factor ends i) after a predetermined number of sequences, ii) when the instrument is subjected to a torque change of direction, or iii) when the predetermined parameters resulting from the torque dependent function are equal to the parameters of the first sequence.

10. A system for the endodontic treatment of a root canal, comprising
(i) an endodontic instrument;
(ii) an endodontic handpiece having a drive motor for rotating the endodontic instrument releasably attached to the handpiece; and
(iii) a control unit for controlling the rotation of the endodontic instrument according to one or more predetermined rotational sequences, wherein the control unit is configured to:
(a) reciprocate the endodontic instrument in a first sequence which comprises one or more predetermined parameters selected from A) a forward angle αF, B) a reverse angle αR, C) a progression angle, D) speed, and E) frequency, while measuring a torque exerted on the instrument during the first sequence;
(b) use the torque measurement in step (a) to determine and apply a second sequence according to a predetermined continuous torque dependent function, wherein if the torque measurement greater than a previously determined amount, one or more of the predetermined parameters in step (a) is decreased in a predetermined fashion, wherein a torque exerted on the instrument during the second sequence is measured;
(c) optionally use the torque measurement from an immediate previous sequence to determine and apply a subsequent sequence according to the predetermined continuous torque dependent function wherein if the torque measurement or greater than a previously determined amount, one or more of the predetermined parameters in step (b) is decreased in a predetermined fashion, and wherein if the torque measurement is less than a previously determined amount, one or more of the predetermined parameters in step (b) increased in a predetermined fashion, and
(d) optionally repeat step (c).

11. The system of claim 10, wherein the predetermined continuous torque dependent function decreases the progression angle when the torque measurement is greater than the previously determined amount.

12. The system of claim 10, wherein the progression angle is decreased by decreasing the forward angle in a greater amount than the reverse angle.

13. The system of claim 10, wherein the reverse angle remains substantially constant

14. The system of claim 10, wherein the forward angle remains substantially constant.

15. The system of claim 10, wherein the forward angle is greater than or equal to the reverse angle.

16. The system of claim 10, wherein the reverse angle is greater than the forward angle.

17. The system of claim 10, wherein the predetermined continuous torque dependent function further comprises a predefined torque dependent damping factor.

18. The system of claim 17, wherein the predefined damping factor ends i) after a predetermined number of sequences, ii) when the instrument is subjected to a torque change of direction, or iii) when the predetermined parameters resulting from the torque dependent function are equal to the parameters of the first sequence.
